(19) United States
(12) Patent Application Publication
(10) Pub. No.: US 2008/0227023 A1
(43) Pub. Date: Sep. 18, 2008

(54) PROCESSING POSITIVE-WORKING IMAGEABLE ELEMENTS WITH HIGH pH DEVELOPERS

(76) Inventors: Celin Savariar-Hauck, Badenhausen (DE); Manuel Klamt, Seesen-Bilderlahe (DE); Rene Ullrich, Trebitz (DE)

Correspondence Address: Andrew J. Anderson;Patent Legal Staff, Eastman Kodak Company, 343 State Street, Rochester, NY, 14650-2201, US

(21) Appl. No.: 11/686,981

(22) Filed: Mar. 16, 2007

(51) Int. Cl. G03C 8/02

(52) U.S. Cl. 430/199

(57) ABSTRACT

A positive-working imageable element comprises inner and outer layers. The ink receptive outer layer includes a phenolic resin binder that is soluble in a developer having a pH greater than 11. Dissolution suppressing components for the phenolic resin binder are generally excluded from the outer layer or present at a very low amount.

### FIELD OF THE INVENTION

This invention relates to a method of processing imaged multi-layer positive-working imageable elements having improved developer solubility in higher pH developers.

### BACKGROUND OF THE INVENTION

In conventional or “wet” lithographic printing, ink receptive regions, known as image areas, are generated on a hydrophilic surface. When the surface is moistened with water and ink is applied, the hydrophilic regions retain the water and repel the ink, and the ink receptive regions accept the ink and repel the water. The ink is transferred to the surface of a material upon which the image is to be reproduced. For example, the ink can be first transferred to an intermediate blanket that in turn is used to transfer the ink to the surface of the material upon which the image is to be reproduced.

Imageable elements useful to prepare lithographic printing plates typically comprise an imageable layer applied over the hydrophilic surface of a substrate. The imageable layer includes one or more radiation-sensitive components that can be dispersed in a suitable binder. Alternatively, the radiation-sensitive component can also be the binder material. Following imaging, either the imaged regions or the non-imaged regions of the imageable layer are removed by a suitable developer, revealing the underlying hydrophilic surface of the substrate. If the imaged regions are removed, the element is considered as positive-working. Conversely, if the non-imaged regions are removed, the element is considered as negative-working. In each instance, the regions of the imageable layer (that is, the image areas) that remain are ink-receptive, and the regions of the hydrophilic surface revealed by the developing process accept water and aqueous solutions, typically a fountain solution, and repel ink.

Direct digital imaging has become increasingly important in the printing industry. Imageable elements for the preparation of lithographic printing plates have been developed for use with infrared lasers. Thermally imageable, multi-layer elements are described, for example, U.S. Pat. Nos. 6,294,311 (Shimazu et al.), 6,352,812 (Shimazu et al.), 6,593,055 (Shimazu et al.), 6,352,811 (Patel et al.), and 6,528,228 (Savariar-Hauck et al.), U.S. Patent Application Publication 2004/0067432 A1 (Kitson et al.). U.S. Patent Application Publication 2005/0037280 (Loccufier et al.) describes heat-sensitive printing plate precursors that comprise a phenolic developer-soluble polymer and an infrared radiation absorbing agent in the same layer.

Additional positive-working thermally imageable elements are described and used for making lithographic printing plates using various developers in U.S. Pat. Nos. 6,200,727 (Urano et al.), 6,358,669 (Savariar-Hauck et al), 6,534,238 (Savariar-Hauck et al.), and 6,555,291 (Savariar-Hauck).

### PROBLEM TO BE SOLVED

After thermal imaging, the imaged positive-working elements are developed to remove exposed regions to expose the hydrophilic substrate. Low pH (below pH 11) developers have been used to process imaged elements that contain dissolution suppressing components such as triarylmethane dyes (for example, ethyl violet) in the upper layer or topcoat (see for example, U.S. Pat. No. 6,555,291, noted above).

U.S. Pat. No. 6,358,669 (noted above) describes processing multi-layer positive-working elements with either high pH (over pH 11) or low pH developers.

Although lower pH developers are usually preferred over higher pH developers due to lack of carbon dioxide effect and as being less corrosive to aluminum, the elements known in the art so that are developed with high pH and low pH developers may have less than desired imaging speed and may exhibit gloss or other undesirable physical or morphological properties in the outer layer, causing problems in computer-to-press imaging devices. These problems relate to the requirement of forming an adequate amount of holes in the outer layer in the IR-exposed regions.

However, higher exposure energy may result in ablation that causes numerous problems in the imaging environment.

Thus, there is a need to provide a multi-layer imaging element where the IR-exposed regions can be easily removed by a developer far below the normal IR-exposure energy usually needed for substantial hole formation in the outer layer.

### SUMMARY OF THE INVENTION

This invention provides a method of making an imaged element comprising:

A) imagewise exposing an imageable element using a source of radiation to provide both exposed and non-exposed regions in the imageable element, and

B) developing the imagewise exposed imageable element with a developer having a pH greater than 11 to remove the exposed regions,
wherein the imageable element comprises a substrate having thereon, in order:
an inner layer comprising a first polymeric binder, and
an ink receptive outer layer comprising a second polymeric binder that: (1) is different than the first polymeric binder, (2) is soluble in the developer having a pH greater than 11, and (3) is a resin having phenolic hydroxy groups,
the outer layer being substantially free of dissolution suppressing components for the second polymeric binder.

In some embodiments of the invention, a method of making an imaged lithographic element comprises:

A) imagewise exposing an imageable lithographic printing plate precursor using a source of infrared radiation to provide both exposed and non-exposed regions in the imageable precursor, and

B) developing the imagewise exposed imageable lithographic printing plate precursor with a developer having a pH of 12 or more to remove the exposed regions,
wherein the lithographic printing plate precursor comprises an aluminum substrate having thereon, in order:
an inner layer comprising a first polymeric binder and an IR absorbing dye having a maximum absorption at from about 700 to about 1200 nm and is present only in the inner layer in an amount of at least 3 weight %, and
an ink receptive outer layer comprising a second polymeric binder that: (1) is different than the first polymeric binder, (2) is soluble in the developer having a pH of 12 or more, (3) is a novolak resin, and (4) is present in the outer layer at a dry coverage of from about 75 to 100 weight % based on outer layer total dry weight,
wherein dissolution suppressing components for the second polymeric binder are absent or present in the outer layer in an amount of less than 0.5 weight %.

The present invention allows for the optimal use of high pH developers to process positive-working imageable elements from which dissolution suppressing components are generally omitted. These imageable elements contain certain phenolic binders in the outer layer that are very soluble in the high pH developer. It was previously thought that the use of such phenolic binders in the outer layer of imageable elements would require a dissolution suppressing component for sufficient image protection during development. We unexpectedly discovered that this is not true. To achieve the advantages of this invention, we carried out substantial research with various polymeric binder, and unexpectedly found that outer layers free of dissolution suppressing agents provide imageable elements with high sensitivity.

Thus, the method of the invention provides desired imaging and development speed without the dissolution suppressing component. The reasons for this unexpected achievement are unknown. While not being bound to any particular mechanism, it is believed that an “interfacial barrier layer” may form between the upper and lower layers from a mixture of components from both layers during manufacturing. This interfacial barrier layer may be more readily cracked or broken up during thermal imaging so that developer can readily penetrate to the lower layer and quickly remove exposed regions of all layers during processing. This provides an opportunity to achieve desired “clean-out” at relatively lower imaging energies.

Thus, the invention provides higher productivity as the imaging time can be reduced by up to 50%. The ability to image at lower exposure energy reduces the possibility of ablation in the imaged layer(s). Problems associated with surface deformation at high exposure energies can be avoided with higher element sensitivity.

### DETAILED DESCRIPTION OF THE INVENTION

### Definitions

Unless the context indicates otherwise, when used herein, the terms “imageable element”, “positive-working imageable element”, and “printing plate precursor” are meant to be references to embodiments useful in the practice of the method of the present invention.

In addition, unless the context indicates otherwise, the various components described herein such as “first polymeric binder”, “second polymeric binder”, “dissolution suppressing components” (or “dissolution inhibitor”), “added copolymer”, “coating solvent”, “infrared radiation absorbing compound”, “developer”, and similar terms also refer to mixtures of such components. Thus, the use of the article “a” or “an” is not necessarily meant to refer to only a single component.

By the term “remove said exposed regions” during development, we mean that the exposed regions of the outer layer and the corresponding regions of underlying layers are selectively and preferentially removed by the developer after thermal exposure.

By “lower pH developer”, we mean developers that have a pH of 11 or less, and generally a pH of from about 7 to 11.

By “high pH developer”, we mean developers that have a pH greater than 11.

Unless otherwise indicated, percentages refer to percents by dry weight.

For clarification of definitions for any terms relating to polymers, reference should be made to “Glossary of Basic Terms in Polymer Science” as published by the International Union of Pure and Applied Chemistry (“IUPAC”), Pure Appl. Chem. 68, 2287-2311 (1996). However, any definitions explicitly set forth herein should be regarded as controlling.

Unless otherwise indicated, the term “polymer” refers to high and low molecular weight polymers including oligomers and includes homopolymers and copolymers.

The term “copolymer” refers to polymers that are derived from two or more different monomers. That is, they comprise recurring units having at least two different chemical structures.

The term “backbone” refers to the chain of atoms in a polymer to which a plurality of pendant groups can be attached. An example of such a backbone is an “all carbon” backbone obtained from the polymerization of one or more ethylenically unsaturated polymerizable monomers. However, other backbones can include heteroatoms wherein the polymer is formed by a condensation reaction or some other means.

### Uses

The positive-working imageable elements described herein can be used in a number of ways. A desired use is as precursors to forming lithographic printing plates as described in more detail below. However, this is not meant to be their only use. For example, the imageable elements can also be used as thermal patterning systems and to form masking elements and printed circuit boards.

### Imageable Elements

In general, the imageable element comprises a substrate, an inner layer (also known in the art as an “underlayer”), and an outer layer (also known in the art as a “top layer” or “topcoat”) disposed over the inner layer. Before thermal imaging, the outer layer is generally not soluble or removable by a developer within the usual time allotted for development, but after thermal imaging, the exposed regions of the outer layer are soluble in the higher pH alkaline developer. The inner layer is also generally removable by the developer. An infrared radiation absorbing compound (defined below) can also be present in the imageable element, and it is usually present in the inner layer but it may alternatively or additionally be present in a separate layer between the inner and outer layers.

The imageable elements are formed by suitable application of an inner layer composition onto a suitable substrate. This substrate can be an untreated or uncoated support but it is usually treated or coated in various ways as described below prior to application of the inner layer composition. The substrate generally has a hydrophilic surface or at least a surface that is more hydrophilic than the outer layer composition. The substrate comprises a support that can be composed of any material that is conventionally used to prepare imageable elements such as lithographic printing plates. It is usually in the form of a sheet, film, or foil, and is strong, stable, and flexible and resistant to dimensional change under conditions of use so that color records will register a full-color image. Typically, the support can be any self-supporting material including polymeric films (such as polyester, polyethylene, polycarbonate, cellulose ester polymer, and polystyrene films), glass, ceramics, metal sheets or foils, or stiff papers (including resin-coated and metallized papers), or a lamination of any of these materials (such as a lamination of an aluminum foil and a polyester film). Metal supports include sheets or foils of aluminum, copper, zinc, titanium, and alloys thereof.

Polymeric film supports may be modified on one or both surfaces with a “subbing” layer to enhance hydrophilicity, or paper supports may be similarly coated to enhance planarity. Examples of subbing layer materials include but are not limited to, alkoxysilanes, amino-propyltriethoxysilanes, glycidioxypropyl-triethoxysilanes, and epoxy functional polymers, as well as conventional hydrophilic subbing materials used in silver halide photographic films (such as gelatin and other naturally occurring and synthetic hydrophilic colloids and vinyl polymers including vinylidene chloride copolymers).

One substrate is composed of an aluminum support that may be treated using techniques known in the art, including physical graining, electrochemical graining, chemical graining, and anodizing. The aluminum sheet can be subjected to electrochemical graining and anodized with sulfuric acid or phosphoric acid.

An interlayer between the support and inner layer may be formed by treatment of the aluminum support with, for example, a silicate, dextrine, calcium zirconium fluoride, hexafluorosilicic acid, sodium phosphate/sodium fluoride, poly(vinyl phosphonic acid) (PVPA), vinyl phosphonic acid copolymer, poly(acrylic acid), or acrylic acid copolymer. For example, an electrochemically grained and anodized aluminum support is treated with PVPA using known procedures to improve surface hydrophilicity.

The thickness of the substrate can be varied but should be sufficient to sustain the wear from printing and thin enough to wrap around a printing form such as a cylinder. Such embodiments can include a treated aluminum foil having a thickness of from about 100 to about 600 μm.

The backside (non-imaging side) of the substrate may be coated with antistatic agents and/or slipping layers or a matte layer to improve handling and “feel” of the imageable element.

The substrate can also be a cylindrical surface having the various layer compositions applied thereon, and thus be an integral part of the printing press. The use of such imaged cylinders is described for example in U.S. Pat. No. 5,713,287 (Gelbart).

The inner layer is disposed between the outer layer and the substrate. Typically, it is disposed directly on the substrate. The inner layer comprises a first polymeric binder that is removable by the high pH developer and generally soluble in the high pH developer to reduce sludging. In addition, the first polymeric binder is generally insoluble in the solvent used to coat the outer layer so that the outer layer can be coated over the inner layer without dissolving the inner layer. Mixtures of these first polymeric binders can be used if desired in the inner layer.

Useful first polymeric binders for the inner layer include (meth)acrylonitrile polymers, (meth)acrylic resins comprising carboxy groups, polyvinyl acetals, maleated wood rosins, styrene-maleic anhydride copolymers, (meth)acrylamide polymers including polymers derived from N-alkoxyalkyl methacrylamide, polymers derived from an N-substituted cyclic imide, polymers having pendant cyclic urea groups, and combinations thereof. First polymeric binders that provide resistance both to fountain solution and aggressive washes are disclosed in U.S. Pat. No. 6,294,311 (noted above).

Useful first polymeric binders include (meth)acrylonitrile polymers, and polymers derived from an N-substituted cyclic imide (especially N-phenylmaleimide), a (meth)acrylamide (especially methacrylamide), a (meth)acrylic acid (especially methacrylic acid), and optionally a monomer having a pendant cyclic urea group. Representative first polymeric binders of this type are copolymers that comprise from about 20 to about 75 mol % and typically from about 35 to about 60 mol % or recurring units derived from N-phenylmaleimide, N-cyclohexylmaleimide, N-(4-carboxyphenyl)maleimide, N-benzylmaleimide, or a mixture thereof, from about 10 to about 50 mol % and typically from about 15 to about 40 mol % of recurring units derived from acrylamide, methacrylamide, or a mixture thereof, and from about 5 to about 30 mol % and typically about 10 to about 30 mol % of recurring units derived from methacrylic acid. Other hydrophilic monomers, such as hydroxyethyl methacrylate, may be used in place of some or all of the methacrylamide. Other alkaline soluble monomers, such as acrylic acid, may be used in place of some or all of the methacrylic acid. Optionally, these polymers can also include recurring units derived from (meth)acrylonitrile or N-[2-(2-oxo-1-imidazolidinyl)ethyl]-methacrylamide.

The bakeable inner layers described in WO 2005/018934 (Kitson et al.) and U.S. Pat. No. 6,893,783 (Kitson et al.) may also be used.

Other useful first polymeric binders can comprise, in polymerized form, from about 5 mol % to about 30 mol % (typically from about 10 mol % to about 30 mol % of recurring units) derived from an ethylenically unsaturated polymerizable monomer having a carboxy group (such as acrylic acid, methacrylic acid, itaconic acid, and other similar monomers known in the art (acrylic acid and methacrylic acid are preferred), from about 20 mol % to about 75 mol % (typically from about 35 mol % to about 60 mol %) of recurring units derived from N-phenylmaleimide, N-cyclohexylmaleimide, or a mixture thereof, optionally, from about 5 mol % to about 50 mol % (typically when present from about 15 mol % to about 40 mol %) of recurring units derived from methacrylamide, and from about 3 mol % to about 50 mol % (typically from about 10 mol % to about 40 mol % of one or more recurring units derived from monomer compounds of the following Structure (IV):

CH₂═C(R₂)—C(═O)—NH—CH₂—OR₁ (IV)

wherein R₁ is a C₁ to C₁₂ alkyl, phenyl, C₁ to C₁₂ substituted phenyl, C₁ to C₁₂ aralkyl, or Si(CH₃)₃, and R₂ is hydrogen or methyl. Methods of preparation of certain of these polymeric materials are disclosed in U.S. Pat. No. 6,475,692 (Jarek).

The first polymeric binder useful in the inner layer can also be hydroxy-containing polymeric material composed of recurring units derived from two or more ethylenically unsaturated monomers wherein from about 1 to about 50 mol % (typically from about 10 to about 40 mol %) of the recurring units are derived from on or more of the monomers represented by the following Structure (V):

CH₂═C(R₃)C(═O)NR₄(CR₅R₆)ₘOH (V)

wherein R₃, R₄, R₅, R₆ are independently hydrogen, substituted or unsubstituted lower alkyl having 1 to 10 carbon atoms (such as methyl, chloromethyl, ethyl, iso-propyl, t-butyl, and n-decyl), or substituted or unsubstituted phenyl, and m is 1 to 20.

Preferred embodiments of hydroxy-containing first polymeric binders can be represented by the following Structure (VI):

-(A)ₓ-(B)_{y}—(C)_{z}— (VI)

wherein A represents recurring units represented by the following Structure (VII):

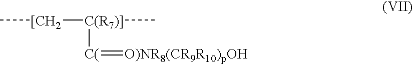

wherein R₇ through R₁₀ and p are as defined the same as R₃ through R₆ and m noted above for Structure (V).

In Structure (VI), B represents recurring units comprising acidic functionality or an N-maleimide group, and C represents recurring units different from A and B, x is from about 1 to about 50 mol % (typically from about 10 to about 40 mol %), y is from about 40 to about 90 mol % (from about 40 to about 70 mol %), and z is 0 to about 70 mol % (typically from 0 to about 50 mol %), based on total recurring units.

In some embodiments of Structure (VI):

A represents recurring units derived from one or both of N-hydroxymethylacrylamide and N-hydroxymethylmethacrylamide,

B represents recurring units derived from one or more of N-phenylmaleimide, N-cyclohexylmaleimide, N-benzylmaleimide, N-(4-carboxyphenyl)maleimide, (meth)acrylic acid, and vinyl benzoic acid,

C represents recurring units derived from one or more of a styrenic monomer (such as styrene and derivatives thereof), meth(acrylate) ester, N-substituted (meth)acrylamide, maleic anhydride, (meth)acrylonitrile, allyl acrylate, and a compound represented by the following Structure (VII):

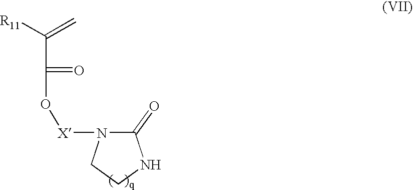

wherein R₁₁ is hydrogen, methyl, or halo, X′ is alkylene having 2 to 12 carbon atoms, q is 1 to 3, x is from about 10 to 40 mol %, y is from about 40 to about 70 mol %, and z is from 0 to about 50 mol %, all based on total recurring units.

In more other embodiments for Structure VI, B represents recurring units derived from at least one of N-phenylmaleimide, N-cyclohexylmaleimide, N-benzylmaleimide, N-(4-carboxyphenyl)maleimide in an amount of from about 20 to about 50 mol %, and recurring units derived from at least one of (meth)acrylic acid and vinyl benzoic acid in an amount of from about 10 to about 30 mol %, based on total recurring units.

In such embodiments, C represents recurring units derived from methacrylamide, (meth)acrylonitrile, maleic anhydride, or

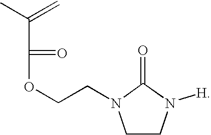

Still other useful first polymeric binders are addition or condensation polymers that have a polymer backbone to which are attached pendant phosphoric acid groups, pendant adamantyl groups, or both types of pendant groups. The pendant adamantyl groups are connected to the polymer backbone at least through a urea or urethane linking group but other linking groups can also be present.

Representative first polymeric binders of this type are shown by the following Structure (VIII):

-(A)ₓ-(B)_{y}— (VIII)

wherein A and B together represents the polymer backbone in which A further comprises recurring units comprising pendant phosphoric acid groups, pendant adamantyl groups, or both, B further represents different recurring units, x represents 5 to 100 weight %, and y represents 0 to 95 weight %, provided that if A comprises pendant adamantyl groups, such groups are connected to the polymer backbone through a urea or urethane linking group (but other linking groups can also be present).

In addition, such first polymeric binders can be represented by the following Structure (IX):

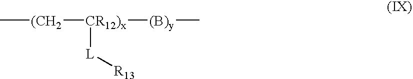

wherein R₁₂ represents hydrogen, a substituted or unsubstituted lower alkyl group having 1 to 4 carbon atoms (such as methyl, ethyl, n-propyl, or t-butyl), or a halo group.

L represents a direct bond or a linking group comprising 1 or more carbon atoms and optionally 1 or more heteroatoms in the linking chain. Useful linking groups can include, but are not limited to, substituted or unsubstituted, linear or branched alkylene groups having 1 to 10 carbon atoms (such as methylene, methoxymethylene, ethylene, iso-propylene, n-butylene, t-butylene, and n-hexylene), substituted or unsubstituted cycloalkylene groups having 5 to 10 carbon atoms in the cyclic group (such as 1,3-cyclopentylene and 1,4-cyclohexylene), substituted or unsubstituted arylene groups having 6 to 10 carbon atoms in the cyclic group (such as 1,4-phenylene, 3-methyl-1,4-phenylene, or naphthylene), or combinations thereof, such as arylenealkylene, alkylenearylene, and alkylenearylenealkylene groups. The L linking groups can also include one or more oxy, thio, amido, carbonyl, oxycarbonyl, carbonyloxy, carbonamido, sulfonamido, urea, urethane, and carbonate [—O—C(═O)—O—] groups within the linking chain, with or without any of the alkylene, cycloalkylene, and arylene groups described above. L can include combinations of two or more of these groups.

Thus, L can be a direct bond or one or more of alkylene groups having 1 to 4 carbon atoms in the linking chain, carbonyloxy, urea, urethane, alkyleneoxy, alkylenecarbonyloxy, and carboxyalkylene groups. In particular, L can comprise at least one —C(═O)O— (carbonyloxy), —NH—C(═O)—NH— (urea), —C(═O)—O—(CH₂)₂—, or —NH—C(═O)—O— (urethane) group.

In Structure (IX), R₁₃ represents a pendant phosphoric acid group, a pendant adamantyl group, or both types of pendant groups. The solvent-resistant polymer can comprise one or more different recurring units having phosphoric acid groups or one or more different recurring units having adamantyl groups. Alternatively, the polymer can include a mixture of one or more different recurring units having phosphoric acid groups and one or more different recurring units having adamantyl groups. When R′ is a pendant adamantyl group, L comprises a urea or urethane linking group within the linking chain.

In referring to “phosphoric acid” groups, it is also intended to include the corresponding salts of the phosphoric acid, including but not limited to, alkali metal salts and ammonium salts. Any suitable positive counterion can be used with the pendant phosphoric acid groups as long as the counterion does not adversely affect the performance of the resulting polymer or other desired imaging properties.

In some embodiments of Structures VIII and IX, x is from about 5 to about 20 weight % and y is from about 80 to about 95 weight % when A represents recurring units comprising pendant phosphoric acid groups. Alternatively, x is from about 5 to about 40 weight % and B is from about 60 to about 95 weight % when A represents recurring units comprising pendant adamantyl groups.

Useful ethylenically unsaturated polymerizable monomers that can used to provide the A recurring units described above for Structures VIII and IX include, but are not limited to the following compounds represented by the following Structures A1 through A5:

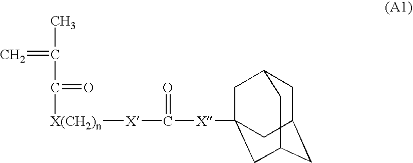

wherein X is oxy, thio, or —NH— (typically oxy), X′ is —NH— or oxy, X″ is oxy or —NH—, and n is 1 to 6 (typically 2 to 4).

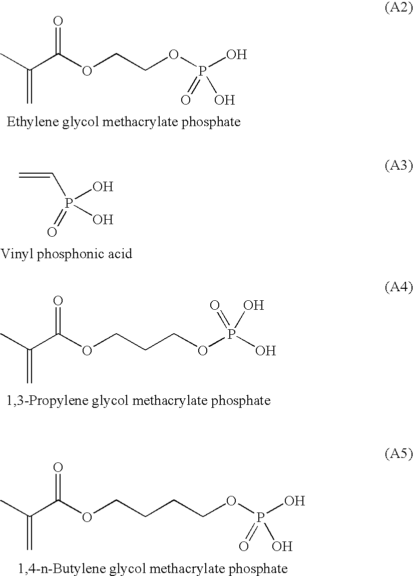

In Structures (VIII) and (IX), B represents recurring units derived from one or more ethylenically unsaturated polymerizable monomers that do not have pendant phosphoric acid groups or adamantyl groups. A variety of monomers can be used for providing B recurring units, including styrenic monomers, (meth)acrylamide, (meth)acrylic acids or esters thereof, (meth)acrylonitrile, vinyl acetate, maleic anhydride, N-substituted maleimide, or mixtures thereof.

The recurring units represented by B can be derived from styrene, N-phenylmaleimide, methacrylic acid, (meth)acrylonitrile, or methyl methacrylate, or mixtures of two or more of these monomers.

In some embodiments, the first polymeric binder can be represented by Structure (VIII) described above in which x is from about 5 to about 30 weight % (more typically, from about 5 to about 20 weight %) and B represents recurring units derived from:

a) one or more of styrene, N-phenylmaleimide, methacrylic acid, and methyl methacrylate, wherein these recurring units comprise from 0 to about 70 weight % (more typically from about 10 to about 50 weight %) of all recurring units in the solvent-resistant polymer, and

b) one or more of acrylonitrile or methacrylonitrile, or mixtures thereof, wherein these recurring units comprise from about 20 to about 95 weight % (more typically from about 20 to about 60 weight %) of all recurring units in the solvent-resistant polymer.

Still other useful first polymeric binders comprise a backbone and have attached to the backbone the following Structure Q group:

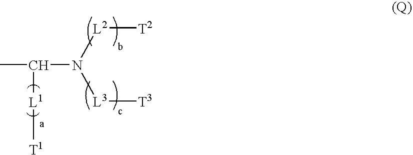

wherein L¹, L², and L³ independently represent linking groups, T¹, T², and T³ independently represent terminal groups, and a, b, and c are independently 0 or 1.

More particularly, each of L¹, L², and L³ is independently a substituted or unsubstituted alkylene having 1 to 4 carbon atoms (such as methylene, 1,2-ethylene, 1,1-ethylene, n-propylene, iso-propylene, t-butylene, and n-butylene groups), substituted cycloalkylene having 5 to 7 carbon atoms in the cyclic ring (such as cyclopentylene and 1,4-cyclohexylene), substituted or unsubstituted arylene having 6 to 10 carbon atoms in the aromatic ring (such as 1,4-phenylene, naphthylene, 2-methyl-1,4-phenylene, and 4-chloro-1,3-phenylene groups), or substituted or unsubstituted, aromatic or non-aromatic divalent heterocyclic group having 5 to 10 carbon and one or more heteroatoms in the cyclic ring (such as pyridylene, pyrazylene, pyrimidylene, or thiazolylene groups), or any combinations of two or more of these divalent linking groups. Alternatively, L² and L³ together can represent the necessary atoms to form a carbocyclic or heterocyclic ring structure. Typically, L¹ is a carbon-hydrogen single bond or a methylene, ethylene, or phenylene group, and L² and L³ are independently hydrogen, methyl, ethyl, 2-hydroxyethyl, or cyclic —(CH₂)₂O(CH₂CH₂)— groups.

T¹, T², and T³ are independently terminal groups such as hydrogen, or substituted or unsubstituted alkyl groups having 1 to 10 carbon atoms (such as methyl, ethyl, iso-propyl, t-butyl, n-hexyl, methoxymethyl, phenylmethyl, hydroxyethyl, and chloroethyl groups), substituted or unsubstituted alkenyl groups having 2 to 10 carbon atoms (such as ethenyl and hexenyl groups), substituted or unsubstituted alkynyl groups (such as ethynyl and octynyl groups), substituted or unsubstituted cycloalkyl groups having 5 to 7 carbon atoms in the cyclic ring (such as cyclopentyl, cyclohexyl, and cycloheptyl groups), substituted or unsubstituted heterocyclic groups (both aromatic and non-aromatic) having a carbon atom and one or more heteroatoms in the ring (such as pyridyl, pyrazyl, pyrimidyl, thiazolyl, and indolyl groups), and substituted or unsubstituted aryl groups having 6 to 10 carbon atoms in the aromatic ring (such as phenyl, naphthyl, 3-methoxyphenyl, benzyl, and 4-bromophenyl groups). Alternatively, T² and T³ together represent the atoms necessary to form a cyclic structure that can also contain fused rings. In addition, when “a” is 0, T³ is not hydrogen.

In some embodiments, the Structure Q group can be directly attached to an α-carbon atom in the polymer backbone, the α-carbon atom also having attached thereto an electron withdrawing group. In other embodiments, the Structure Q group is indirectly attached to the polymer backbone through a linking group.

These first polymeric binders can be prepared by the reaction of an α-hydrogen in the polymer precursor with a first compound comprising an aldehyde group and a second compound comprising an amine group as described in U.S. Patent Application Publication 2005/0037280 (Loccufier et al.).

The first polymeric binders can also be represented by the following Structure (X):

-(A)ₓ-(B)_{y}— (X)

wherein A represents recurring units derived from one or more ethylenically unsaturated polymerizable monomers that comprise the same or different Q groups, B represents recurring units derived from one or more different ethylenically unsaturated polymerizable monomers that do not comprise Q groups.

More particularly, the A recurring units in Structure X can be represented by the following Structure (Xa) or (Xb):

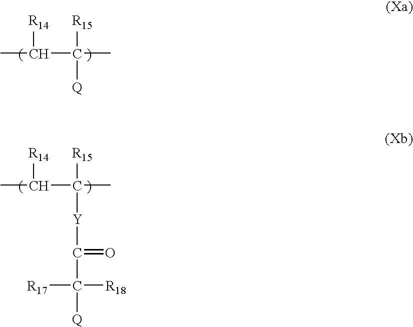

wherein R₁₄ and R₁₆ are independently hydrogen or a halo, substituted or unsubstituted alkyl having 1 to 7 carbon atoms (such as methyl, ethyl, n-propyl, iso-propyl, or benzyl), or a substituted or unsubstituted phenyl group. Typically, R₁₄ and R₁₆ are independently hydrogen or a methyl or halo group, and more typically they are independently hydrogen or methyl.

R₁₅ in Structure Xa is an electron withdrawing group as defined above including but are not limited to, cyano, nitro, substituted or unsubstituted aryl groups having 6 to 10 carbon atoms in the carbocyclic ring, substituted or unsubstituted heteroaryl groups having 5 to 10 carbon, sulfur, oxygen, or nitrogen atoms in the heteroaromatic ring, —C(═O)OR₂₀, and —C(═O)R₂₀ groups wherein R₂₀ is hydrogen or a substituted or unsubstituted alkyl having 1 to 4 carbon atoms (such as methyl, ethyl, n-propyl, t-butyl), a substituted or unsubstituted cycloalkyl (such as a substituted or unsubstituted cyclohexyl), or a substituted or unsubstituted aryl group (such as substituted or unsubstituted phenyl). The cyano, nitro, —C(═O)OR₂₀, and —C(═O)R₂₀ groups are preferred and cyano, —C(═O)CH₃, and —C(═O)OCH₃ are most preferred.

R₁₇ and R₁₈ in Structure (Xb) are independently hydrogen or a substituted or unsubstituted alkyl group having 1 to 6 carbon atoms (such as such as methyl, ethyl, n-propyl, t-butyl, n-hexyl), substituted or unsubstituted cycloalkyl having 5 or 6 carbon atoms (such as cyclohexyl), a substituted or unsubstituted aryl group having 6 to 10 carbon atoms (such as phenyl, 4-methylphenyl, and naphthyl), or a —C(═O)R₁₉ group wherein R₁₉ is a substituted or unsubstituted alkyl group (as defined for R₁₇ and R₁₈), a substituted or unsubstituted alkenyl group having 2 to 8 carbon atoms (such as ethenyl and 1,2-propenyl), a substituted or unsubstituted cycloalkyl group (as defined above for R₁₇ and R₁₈), or a substituted or unsubstituted aryl group (as defined above for R₁₇ and R₁₈). Typically, R₁₇ and R₁₈ are independently hydrogen or a substituted or unsubstituted alkyl, cycloalkyl, aryl, or —C(═O)R₁₉ groups as defined above wherein R₁₉ is an alkyl having 1 to 4 carbon atoms.

In Structure (Xb), Y is a direct bond or a divalent linking group. Useful divalent linking groups include but are not limited to oxy, thio, —NR₂₁—, substituted or unsubstituted alkylene, substituted or unsubstituted phenylene, substituted or unsubstituted heterocyclylene, —C(═O)—, and —C(═O)O— groups, or a combination thereof wherein R₂₁ is hydrogen or a substituted or unsubstituted alkyl, substituted or unsubstituted cycloalkyl, or substituted or unsubstituted aryl group, as defined above for R₁₇ and R₁₈. Typically, Y is a direct bond or an oxy, —C(═O)O—, —C(═O)OCH₂CH₂O—, or —C(═O)CH₂CH₂C(═O)CH₂— group.

In Structure (X), x is from about 1 to about 70 mol %, and y is from about 30 to about 99 mol %, based on total recurring units. Typically, x is from about 5 to about 50 mol % and y is from about 50 to about 95 mol %, based on total recurring units.

Also in Structure (X), B can represent recurring units derived from a wide variety of ethylenically unsaturated polymerizable monomers. Particularly useful recurring units are derived from one or more N-substituted maleimides, N-substituted (meth)acrylamides, unsubstituted (meth)acrylamides, (meth)acrylonitriles, or vinyl monomers having an acidic group, and more typically from one or more N-phenylmaleimides, N-cyclohexylmaleimides, N-benzylmaleimides, N-(4-carboxyphenyl)maleimides, (meth)acrylic acids, vinyl benzoic acids, (meth)acrylamides, and (meth)acrylonitriles. Several of these monomers can be copolymerized to provide multiple types of B recurring units. Particularly useful combinations of B recurring units include those derived from two or more of methacrylic acid, methacrylamide, and N-phenylmaleimide.

The first polymeric binders are the predominant polymeric materials in the inner layer. That is, they comprise more than 50% and up to 100% (dry weight) of the total polymeric materials in the inner layer. However, the inner layer may also comprise one or more primary additional polymeric materials, provided these primary additional polymeric materials do not adversely affect the chemical resistance and solubility properties of the inner layer.

Useful primary additional polymeric materials include copolymers that comprises from about 1 to about 30 mole % and typically from about 3 to about 20 mole % of recurring units derived from N-phenylmaleimide, from about 1 to about 30 mole % and typically from about 5 to about 20 mole % of recurring units derived from methacrylamide, from about 20 to about 75 mole % and typically from about 35 to about 60 mole % of recurring units derived from acrylonitrile, and from about 20 to about 75 mole % and typically from about 35 to about 60 mole % of recurring units derived from one or more monomers of the Structure (XI):

CH₂═C(R₂₃)—CO₂—CH₂CH₂—NH—CO—NH-p-C₆H₄—R₂₂ (XI)

wherein R₂₂ is OH, COOH, or SO₂NH₂, and R₂₃ is H or methyl, and, optionally, from about 1 to about 30 mole % and typically, when present, from about 3 to about 20 mole % of recurring units derived from one or more monomers of the Structure (XII):

CH₂═C(R₂₅)—CO—NH-p-C₆H₄—R₂₄ (XII)

wherein R₂₄ is OH, COOH, or SO₂NH₂, and R₂₅ is H or methyl.

The inner layer may also comprise one or more secondary additional polymeric materials that are resins having activated methylol and/or activated alkylated methylol groups. These “secondary additional polymeric materials” in the inner layer should not be confused as the “second polymeric binder” used in the outer layer.

The secondary additional polymeric materials can include, for example resole resins and their alkylated analogs, methylol melamine resins and their alkylated analogs (for example melamine-formaldehyde resins), methylol glycoluril resins and alkylated analogs (for example, glycoluril-formaldehyde resins), thiourea-formaldehyde resins, guanamine-formaldehyde resins, and benzoguanamine-formaldehyde resins. Commercially available melamine-formaldehyde resins and glycoluril-formaldehyde resins include, for example, CYMEL® resins (Dyno Cyanamid) and NIKALAC® resins (Sanwa Chemical).

The resin having activated methylol and/or activated alkylated methylol groups is typically a resole resin or a mixture of resole resins. Resole resins are well known to those skilled in the art. They are prepared by reaction of a phenol with an aldehyde under basic conditions using an excess of phenol. Commercially available resole resins include, for example, GP649D99 resole (Georgia Pacific) and BKS-5928 resole resin (Union Carbide).

Useful secondary additional polymeric materials can also include copolymers that comprise from about 25 to about 75 mole % and about 35 to about 60 mole % of recurring units derived from N-phenylmaleimide, from about 10 to about 50 mole % and typically from about 15 to about 40 mole % of recurring units derived from methacrylamide, and from about 5 to about 30 mole % and typically from about 10 to about 30 mole % of recurring units derived from methacrylic acid. These secondary additional copolymers are disclosed in U.S. Pat. Nos. 6,294,311 and 6,528,228 (both noted above).

The first polymeric binder and the primary and secondary additional polymeric materials useful in the inner layer can be prepared by methods, such as free radical polymerization, that are well known to those skilled in the art and that are described, for example, in Chapters 20 and 21, of Macromolecules, Vol. 2, 2nd Ed., H. G. Elias, Plenum, New York, 1984. Useful free radical initiators are peroxides such as benzoyl peroxide, hydroperoxides such as cumyl hydroperoxide and azo compounds such as 2,2′-azobis(isobutyronitrile) (AIBN). Suitable reaction solvents include liquids that are inert to the reactants and that will not otherwise adversely affect the reaction.

Thus, in some embodiments, the first polymeric binder can comprise one or more of the following resins:

1) a copolymer having pendant carboxy groups and that is derived from one or more of a (meth)-N-substituted cyclic imide, a cyclic urea monomer, (meth)acrylonitrile, 2-[3-(4-hydroxyphenyl)ureido]ethyl(meth)acrylate, and N-alkoxyalkyl (meth)acrylamide, or

2) a resole,

More particularly, in such embodiments, the first polymeric binder can comprise one or more of the following resins:

1) a copolymer comprising pendant carboxy groups and that is derived from a (meth)acrylamide and an N-substituted cyclic imide,

2) a resole, or

3) a copolymer having pendant carboxy groups and that is derived from one or more of a (meth)acrylamide, an N-substituted cyclic imide, 2-[3-(4-hydroxyphenyl)ureido]ethyl methacrylate, and acrylonitrile.

In most embodiments, the inner layer further comprises an infrared radiation absorbing compound (“IR absorbing compounds”) that absorbs radiation at from about 600 to about 1200 and typically at from about 700 to about 1200 nm, with minimal absorption at from about 300 to about 600 nm. This compound (sometimes known as a “photothermal conversion material”) absorbs radiation and converts it to heat. Although one of the polymeric materials may itself comprise an IR absorbing moiety, typically the infrared radiation absorbing compound is a separate compound. This compound may be either a dye or pigments such as iron oxides and carbon blacks. Examples of useful pigments are ProJet 900, ProJet 860 and ProJet 830 (all available from the Zeneca Corporation).

In some embodiments, the infrared radiation absorbing compound is present only in the inner layer.

Useful infrared radiation absorbing compounds also include carbon blacks including carbon blacks that are surface-functionalized with solubilizing groups are well known in the art. Carbon blacks that are grafted to hydrophilic, nonionic polymers, such as FX-GE-003 (manufactured by Nippon Shokubai), or which are surface-functionalized with anionic groups, such as CAB-O-JET® 200 or CAB-O-JET® 300 (manufactured by the Cabot Corporation) are also useful.

IR absorbing dyes (especially those that are soluble in an alkaline developer) are more preferred to prevent sludging of the developer by insoluble material. Examples of suitable IR dyes include but are not limited to, azo dyes, squarilium dyes, croconate dyes, triarylamine dyes, thioazolium dyes, indolium dyes, oxonol dyes, oxaxolium dyes, cyanine dyes, merocyanine dyes, phthalocyanine dyes, indocyanine dyes, indoaniline dyes, merostyryl dyes, indotricarbocyanine dyes, oxatricarbocyanine dyes, thiocyanine dyes, thiatricarbocyanine dyes, merocyanine dyes, cryptocyanine dyes, naphthalocyanine dyes, polyaniline dyes, polypyrrole dyes, polythiophene dyes, chalcogenopyryloarylidene and bi(chalcogenopyrylo) polymethine dyes, oxyindolizine dyes, pyrylium dyes, pyrazoline azo dyes, oxazine dyes, naphthoquinone dyes, anthraquinone dyes, quinoneimine dyes, methine dyes, arylmethine dyes, squarine dyes, oxazole dyes, croconine dyes, porphyrin dyes, and any substituted or ionic form of the preceding dye classes. Suitable dyes are also described in numerous publications including U.S. Pat. Nos. 6,294,311 (noted above) and 5,208,135 (Patel et al.) and the references cited thereon.

Examples of useful IR absorbing compounds include ADS-830A and ADS-1064 (American Dye Source, Baie D'Urfe, Quebec, Canada), EC2117 (FEW, Wolfen, Germany), Cyasorb® IR 99 and Cyasorb® IR 165 (GPTGlendale Inc. Lakeland, Fla.), and IR Dye A used in the Examples below.

Useful IR dyes include but are not limited to, the following compounds:

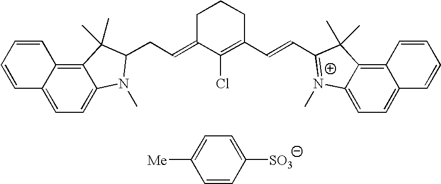

Same as above but with C₃F₇CO₂⁻ as the anion.

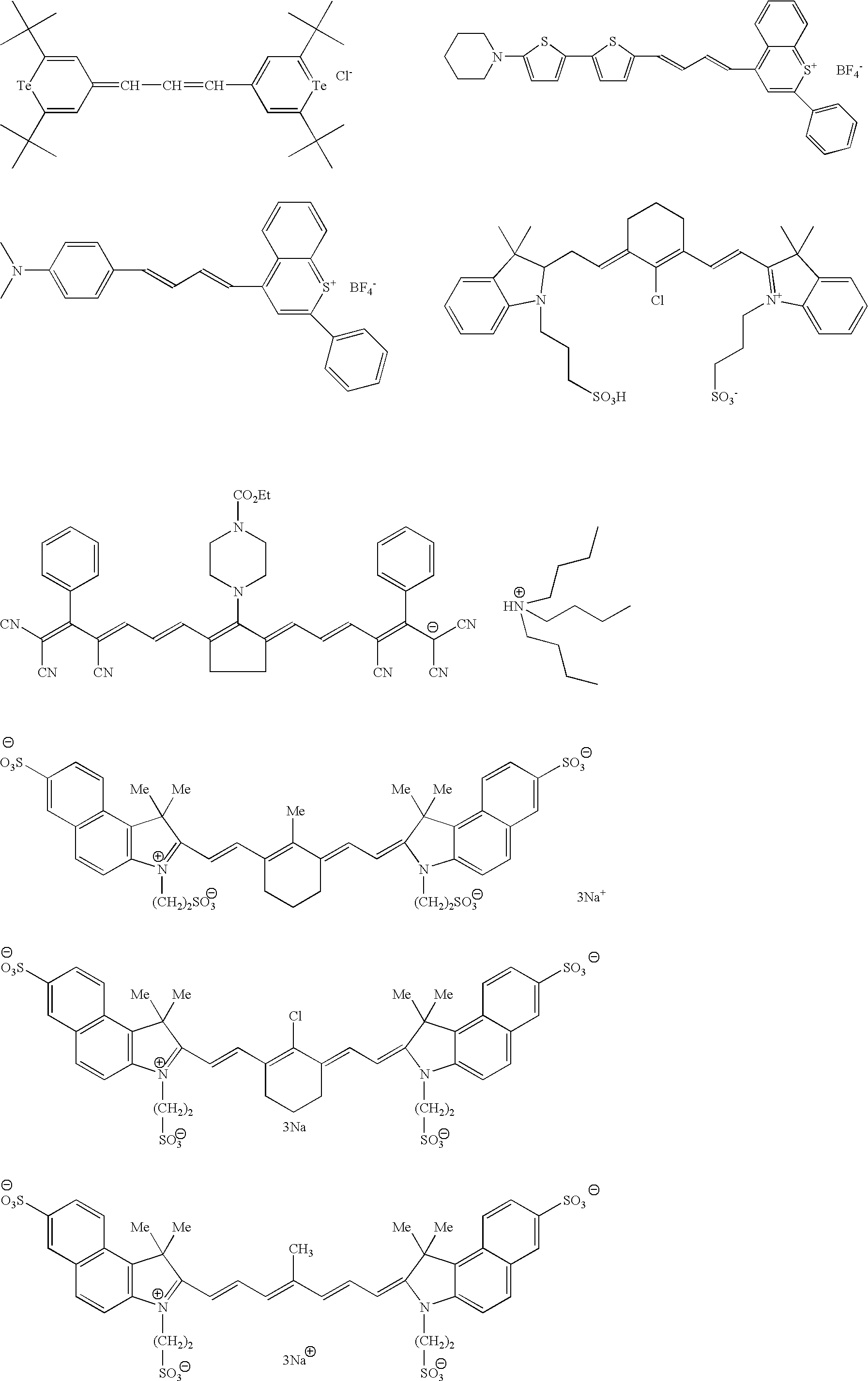

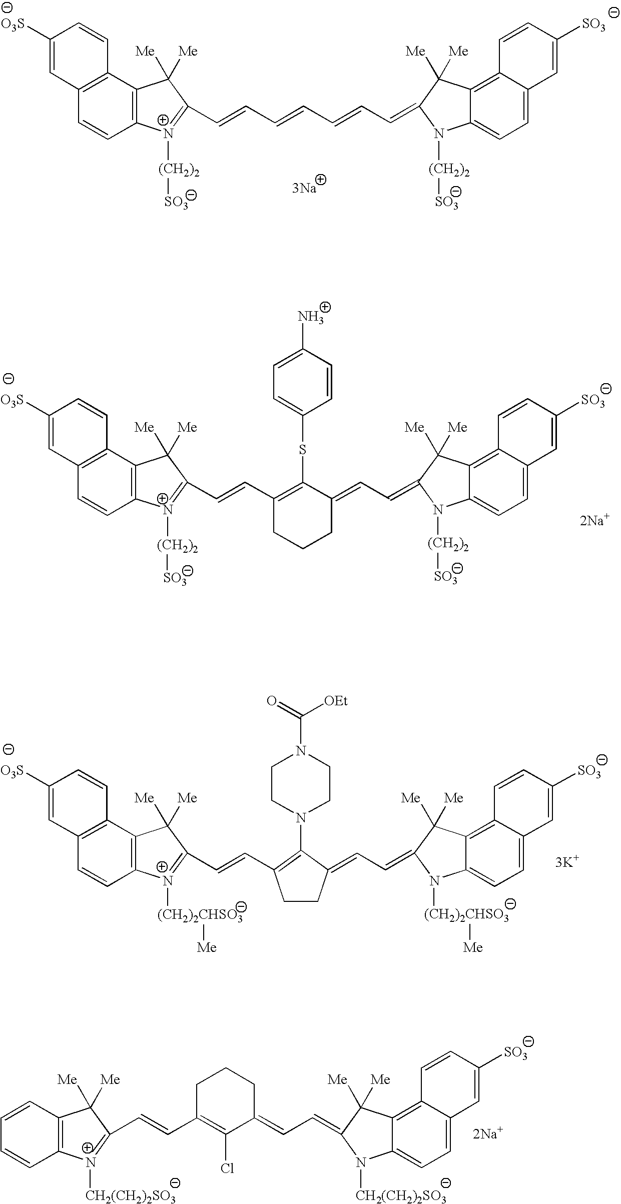

Near infrared absorbing cyanine dyes are also useful and are described for example in U.S. Pat. Nos. 6,309,792 (Hauck et al.), 6,264,920 (Achilefu et al.), 6,153,356 (Urano et al.), 5,496,903 (Watanate et al.). Suitable dyes may be formed using conventional methods and starting materials or obtained from various commercial sources including American Dye Source (Canada) and FEW Chemicals (Germany). Other useful dyes for near infrared diode laser beams are described, for example, in U.S. Pat. No. 4,973,572 (DeBoer).

In addition to low molecular weight IR-absorbing dyes, IR dye moieties bonded to polymers can be used as well. Moreover, IR dye cations can be used, that is, the cation is the IR absorbing portion of the dye salt that ionically interacts with a polymer comprising carboxy, sulfo, phosphor, or phosphono groups in the side chains.

The infrared radiation absorbing compound can be present in the imageable element in an amount of generally at least 3% and up to 30% and typically from about 5 to about 25%, based on the total dry weight of the element. This amount is based on the total dry weight of the layer in which it is located. The particular amount of a given compound to be used could be readily determined by one skilled in the art.

The inner layer can include other components such as surfactants, dispersing aids, humectants, biocides, viscosity builders, drying agents, defoamers, preservatives, antioxidants, and colorants.

The inner layer generally has a dry coating coverage of from about 0.5 to about 2.5 g/m² and typically from about 1 to about 2 g/m². The first polymeric binders described above generally comprise at least 50 weight % and typically from about 60 to about 90 weight % based on the total dry layer weight, and this amount can be varied depending upon what other polymers and chemical components are present. Any primary and secondary additional polymeric materials (such as a novolak, resole, or copolymers noted above) can be present in an amount of from about 5 to about 45 weight % and typically from about 5 to about 25 weight % based on the total dry weight of the inner layer.

The outer layer of the imageable element is disposed over the inner layer and in some embodiments there are no intermediate layers between the inner and outer layers. The outer layer comprises a second polymeric binder that is different than the first polymeric binder described above. It is generally a light-stable, water-insoluble, and soluble in developers having a pH greater than 11 (or in developers having a pH greater than 12 and more typically, in developer having a pH greater than 12.5), and a film-forming resin having phenolic hydroxy groups as defined below. The outer layer is substantially free of infrared radiation absorbing compounds, meaning that none of these compounds are purposely incorporated therein and insubstantial amounts diffuse into it from other layers.

The resins useful as second polymeric binders include but are not limited to, poly(hydroxystyrenes), novolak resins, resole resins, poly(vinyl acetals) having pendant phenolic groups, and mixtures of any of these resins (such as mixtures of one or more novolak resins and one or more resole resins). The novolak resins are most preferred.

Generally, such resins have a number average molecular weight of at least 3,000 and up to 200,000, and typically from about 6,000 to about 100,000, as determined using conventional procedures. Most of these types of resins are commercially available or prepared using known reactants and procedures. For example, the novolak resins can be prepared by the condensation reaction of a phenol with an aldehyde in the presence of an acid catalyst. Typical novolak resins include but are not limited to, phenol-formaldehyde resins, cresol-formaldehyde resins, phenol-cresol-formaldehyde resins, p-t-butylphenol-formaldehyde resins, and pyrogallol-acetone resins, such as novolak resins prepared from reacting m-cresol or a m,p-cresol mixture with formaldehyde using conventional conditions. For example, some useful novolak resins include but are not limited to, xylenol-cresol resins, for example, SPN400, SPN420, SPN460, and VPN1100 (that are available from AZ Electronics) and EP25D40G and EP25D50G (noted below for the Examples) that have higher molecular weights, such as at least 4,000.

Other useful resins include polyvinyl compounds having phenolic hydroxyl groups, include poly(hydroxystyrenes) and copolymers containing recurring units of a hydroxystyrene and polymers and copolymers containing recurring units of substituted hydroxystyrenes.

Also useful are branched poly(hydroxystyrenes) having multiple branched hydroxystyrene recurring units derived from 4-hydroxystyrene as described for example in U.S. Pat. Nos. 5,554,719 (Sounik) and 6,551,738 (Ohsawa et al.), and U.S. Published Patent Applications 2003/0050191 (Bhatt et al.) and 2005/0051053 (Wisnudel et al.), and in copending and commonly assigned U.S. patent application Ser. No. 11/474,020 (filed Jun. 23, 2006 by Levanon et al.), that is incorporated herein by reference. For example, such branched hydroxystyrene polymers comprise recurring units derived from a hydroxystyrene, such as from 4-hydroxystyrene, which recurring units are further substituted with repeating hydroxystyrene units (such as 4-hydroxystyrene units) positioned ortho to the hydroxy group. These branched polymers can have a weight average molecular weight (M_{w}) of from about 1,000 to about 30,000, preferably from about 1,000 to about 10,000, and more preferably from about 3,000 to about 7,000. In addition, they may have a polydispersity less than 2 and preferably from about 1.5 to about 1.9. The branched poly(hydroxystyrenes) can be homopolymers or copolymers with non-branched hydroxystyrene recurring units.

The outer layer is substantially free of dissolution suppressing components for the second polymeric binder(s). By “substantially free”, we mean that the outer layer contains less than 1 weight %, and some embodiments have less than 0.5 weight %, of such compounds (based on total outer layer dry weight). Dissolution suppressing components are known in the art as compounds that reversibly suppress the dissolution of the second polymeric binder in the aqueous alkaline developer. These compounds have polar functional groups that are believed to act as acceptor sites for hydrogen bonding with the hydroxyl groups present in the second polymeric binder. The dissolution suppressing components can be non-polymeric compounds or moieties within polymers. Representative examples of such compounds are described as “solubility-suppressing components” in Cols. 9-11 of U.S. Pat. No. 6,358,669 (noted above). In some of the technical literature, “dissolution suppressing components” have been called “solubility suppressing components”. Ethyl violet is a common compound of this type that may be used as a colorant only if present at less than 0.5 weight %, based on total imageable layer solids.

The outer layer is free of dissolution suppressing components is apparent as the time required to dissolve the dried outer layer coating using a high pH developer when the layer is coated directly on an aluminum substrate is less than 30 seconds whereas the outer layer formulation is used in a multi-layer element, the developer resistance is increased to over 90 seconds.

Thus, the outer layer used in the present invention consists essentially of one or more second polymeric binders. The one or more second polymeric binders are present in the outer layer at a dry coverage of from about 30 to 100 weight % and more typically at from about 80 to about 99 weight %, based on outer layer total dry weight

The outer layer may include colorants. Particularly useful colorants are described for example in U.S. Pat. No. 6,294,311 (noted above) including triarylmethane dyes such as ethyl violet, crystal violet, malachite green, brilliant green, Victoria blue B, Victoria blue R, and Victoria pure blue BO as long as they are present in insufficient amounts to act as dissolution suppressing components. Such colorants can act as contrast dyes that distinguish the non-exposed regions from the exposed regions in the developed imageable element.

The outer layer can optionally also include contrast dyes, printout dyes, coating surfactants, dispersing aids, humectants, biocides, viscosity builders, drying agents, defoamers, preservatives, and antioxidants.

The outer layer generally has a dry coating coverage of from about 0.2 to about 2 g/m² and more typically of from about 0.4 to about 1.5 g/m².

There may be a separate layer that is between and in contact with the inner and outer layers. This separate layer can act as a barrier to minimize migration of radiation absorbing compound(s) from the inner layer to the outer layer. This separate “barrier” layer generally comprises a third polymeric binder that is soluble in the high pH developer. If this third polymeric binder is different from the first polymeric binder(s) in the inner layer, it is usually soluble in at least one organic solvent in which the inner layer first polymeric binders are insoluble. A useful third polymeric binder is a poly(vinyl alcohol). Generally, this barrier layer should be less than one-fifth as thick as the inner layer.

Alternatively, there may be a separate layer between the inner and outer layers that contains the infrared radiation absorbing compound(s), which may also be present in the inner layer, or solely in the separate layer.

### Preparation of the Imageable Element

The imageable element can be prepared by sequentially applying an inner layer formulation over the surface of the substrate (and any other hydrophilic layers provided thereon), and then applying an outer layer formulation over the inner layer using conventional coating or lamination methods. It is important to avoid intermixing of the inner and outer layer formulations.

The inner and outer layers (and any other layers) can be applied by dispersing or dissolving the desired ingredients in a suitable coating solvent, and the resulting formulations are sequentially or simultaneously applied to the substrate using suitable equipment and procedures, such as spin coating, knife coating, gravure coating, die coating, slot coating, bar coating, wire rod coating, roller coating, or extrusion hopper coating. The formulations can also be applied by spraying onto a suitable support (such as an on-press printing cylinder).

The selection of solvents used to coat both the inner and outer layers depends upon the nature of the first and second polymeric binders, other polymeric materials, and other components in the formulations. To prevent the inner and outer layer formulations from mixing or the inner layer from dissolving when the outer layer formulation is applied, the outer layer formulation should be coated from a solvent in which the first polymeric binder(s) of the inner layer are insoluble.

Generally, the inner layer formulation is coated out of a solvent mixture of methyl ethyl ketone (MEK), 1-methoxy-2-propyl acetate (PMA), γ-butyrolactone (BLO), and water, a mixture of MEK, BLO, water, and 1-methoxypropan-2-ol (also known as Dowanol® PM or PGME), a mixture of diethyl ketone (DEK), water, methyl lactate, and BLO, a mixture of DEK, water, and methyl lactate, or a mixture of methyl lactate, methanol, and dioxolane.

The outer layer formulation can be coated out of solvents or solvent mixtures that do not dissolve the inner layer. Typical solvents for this purpose include but are not limited to, butyl acetate, iso-butyl acetate, methyl iso-butyl ketone, DEK, 1-methoxy-2-propyl acetate (PMA), iso-propyl alcohol, PGME and mixtures thereof. Particularly useful is a mixture of DEK and PMA, or a mixture of DEK, PMA, and isopropyl alcohol.

Alternatively, the inner and outer layers may be applied by extrusion coating methods from melt mixtures of the respective layer compositions. Typically, such melt mixtures contain no volatile organic solvents.

Intermediate drying steps may be used between applications of the various layer formulations to remove solvent(s) before coating other formulations. Drying steps may also help in preventing the mixing of the various layers.

After drying the layers, the imageable element can be further “conditioned” with a heat treatment at from about 40 to about 90° C. for at least 4 hours (typically at least 20 hours) under conditions that inhibit the removal of moisture from the dried layers. For example, the heat treatment can be carried out at from about 50 to about 70° C. for at least 24 hours. During the heat treatment, the imageable element is wrapped or encased in a water-impermeable sheet material to represent an effective barrier to moisture removal from the precursor, or the heat treatment of the imageable element is carried out in an environment in which relative humidity is controlled to at least 25%. In addition, the water-impermeable sheet material can be sealed around the edges of the imageable element, with the water-impermeable sheet material being a polymeric film or metal foil that is sealed around the edges of the imageable element.

In some embodiments, this heat treatment can be carried out with a stack comprising at least 100 of the same imageable elements, or when the imageable element is in the form of a coil.

Representative methods for preparing imageable elements useful in this invention are shown below for the Examples.

The imageable elements can have any useful form including, but not limited to, printing plate precursors, printing cylinders, printing sleeves and printing tapes (including flexible printing webs). For example, the imageable members are printing plate precursors useful for providing lithographic printing plates. Printing plate precursors can be of any useful size and shape (for example, square or rectangular) having the requisite inner and outer layers disposed on a suitable substrate.

### Imaging and Development

During use, the imageable element is exposed to a suitable source of infrared using an infrared laser at a wavelength of from about 600 to about 1500 nm and typically from about 700 to about 1200 nm. The lasers used to expose the imageable elements are typically diode lasers, because of the reliability and low maintenance of diode laser systems, but other lasers such as gas or solid-state lasers may also be used. The combination of power, intensity and exposure time for laser imaging would be readily apparent to one skilled in the art. Presently, high performance lasers or laser diodes used in commercially available imagesetters emit infrared radiation at a wavelength of from about 800 to about 850 nm or from about 1040 to about 1120 nm.

The imaging apparatus can function solely as a platesetter or it can be incorporated directly into a lithographic printing press. In the latter case, printing may commence immediately after imaging, thereby reducing press set-up time considerably. The imaging apparatus can be configured as a flatbed recorder or as a drum recorder, with the imageable member mounted to the interior or exterior cylindrical surface of the drum. Examples of useful imaging apparatus are available as models of Creo Trendsetter® imagesetters available from Eastman Kodak Company (Burnaby, British Columbia, Canada) that contain laser diodes that emit near infrared radiation at a wavelength of about 830 nm. Other suitable imaging sources include the Crescent 42T Platesetter that operates at a wavelength of 1064 nm and the Screen PlateRite 4300 series or 8600 series platesetter (available from Screen, Chicago, Ill.). Additional useful sources of radiation include direct imaging presses that can be used to image an element while it is attached to the printing plate cylinder. An example of a suitable direct imaging printing press includes the Heidelberg SM74-DI press (available from Heidelberg, Dayton, Ohio).

Imaging speeds may be in the range of from about 20 to about 250 mJ/cm², more particularly from about 30 to about 150 mJ/cm², or from about 40 to about 100 mJ/cm².

While laser imaging is preferred in the practice of this invention, imaging can be provided by any other means that provides thermal energy in an imagewise fashion. For example, imaging can be accomplished using a thermoresistive head (thermal printing head) in what is known as “thermal printing”, as described for example in U.S. Pat. No. 5,488,025 (Martin et al.) and as used in thermal fax machines and sublimation printers. Thermal print heads are commercially available (for example, as a Fujitsu Thermal Head FTP-040 MCS001 and TDK Thermal Head F415 HH7-1089).

Direct digital imaging is generally used in the invention. The image signals are stored as a bitmap data file on a computer that may be generated by a raster image processor (RIP) or other suitable means. The bitmaps are constructed to define the hue of the color as well as screen frequencies and angles.

Imaging of the imageable element produces an imaged element that comprises a latent image of imaged (exposed) and non-imaged (non-exposed) regions. Developing the imaged element with a suitable high pH developer removes the exposed regions of the outer layer and the underlying portions of underlayers (including the inner layer), and exposes the hydrophilic surface of the substrate. Thus, the imageable elements are “positive-working”. The exposed (or imaged) regions of the hydrophilic surface repel ink while the non-exposed (or non-imaged) regions of the outer layer accept ink.

Generally, development is carried out for a time sufficient to remove the exposed regions of the imaged element, but not long enough to remove the non-exposed regions. Because of the nature of the second polymer binder(s) used in the outer layer, removal of the exposed regions readily occurs during development but the removed portions of the outer layer are readily soluble in the high pH developer, thereby reducing sludge or residue in the developer.

The imaged elements are generally developed using conventional processing conditions using the high pH developers described below. These developers generally have a pH greater than 11 and most embodiments, of at least 11.5, and typically from about pH 12 to about 13.5.

The high pH developers used in the present invention are generally aqueous alkaline solutions of water and various components such as surfactants, chelating agents (such as salts of ethylenediaminetetraacetic acid), and alkaline components (such as inorganic metasilicates, organic metasilicates, hydroxides, and bicarbonates).

The developer can also include one or more “coating-attack suppressing agents” that are developer-soluble compounds that suppress developer attack of the outer layer. “Developer-soluble” means that enough of the agent(s) will dissolve in the developer to suppress attack by the developer. Mixtures of these compounds can be used. Typically, the coating-attack suppressing agents are developer-soluble polyethoxylated, polypropoxylated, or polybutoxylated compounds that include recurring —(CH₂—CHRₐ—O—)— units in which Rₐ is hydrogen or a methyl or ethyl group. Each agent can have the same or different recurring units (in a random or block fashion). Representative compounds of this type include but are not limited to, polyglycols and polycondensation products having the noted recurring units. Examples of such compounds and representative sources, tradenames, or methods of preparing are described for example in U.S. Pat. No. 6,649,324 (Fiebag et al.) that is incorporated herein by reference.

Representative high pH developers useful in this invention include but are not limited to, 3000 Developer, 9000 Developer, GoldStar® Developer, Goldstar® Plus Developer, GoldStar® Premium, GREENSTAR Developer, ThermalPro Developer, PROTHERM Developer, MX1813 Developer, and MX1710 Developer (all available from Eastman Kodak Company), as well as Fuji HDP7 Developer (Fuji Photo) and Energy CTP Developer (Agfa).

In addition to using the noted high pH commercial developers, one skilled in the art could also modify a “lower pH” developer by increasing its pH to greater than 11 by the addition of a suitable base such as a hydroxide or metasilicate. Commercially available lower pH developers that could be modified in this manner include but are not limited to, ND-1 Developer, 989 Developer 980 Developer, SP 200 Developer, “2-in-1” Developer, ProNeg D-501 Developer, 955 Developer, and 956 Developer (available from Eastman Kodak Company), HDN-1 Developer (available from Fuji), and EN 232 Developer (available from Agfa).

Alternatively, one or more high pH developers could be mixed with one or more lower pH developers to provide a developer solution with mixed composition and a pH greater than 11. A skilled artisan would know the proportions of each developer to mix with the other to achieve the desired pH.

Generally, the high pH developer is applied to the imaged element by rubbing or wiping the outer layer with an applicator containing the developer. Alternatively, the imaged element can be brushed with the developer or the developer may be applied by spraying the outer layer with sufficient force to remove the exposed regions. The imaged element is typically immersed in the developer. In all instances, a developed image is produced, particularly in a lithographic printing plate.

Following development, the imaged element can be rinsed with water and dried in a suitable fashion. The dried element can also be treated with a conventional gumming solution (typically gum arabic).

The imaged and developed element can also be baked in a postbake operation that can be carried out to increase run length of the resulting imaged element. Baking can be carried out, for example at from about 220° C. to about 240° C. for from about 7 to about 10 minutes, or at about 120° C. for 30 minutes.

A lithographic ink and fountain solution can be applied to the printing surface of the imaged element for printing. The non-exposed regions of the outer layer take up the ink and fountain solution is taken up by the hydrophilic surface of the substrate revealed by the imaging and development process. The ink is then transferred to a suitable receiving material (such as cloth, paper, metal, glass, or plastic) to provide a desired impression of the image thereon. If desired, an intermediate “blanket” roller can be used to transfer the ink from the imaged member to the receiving material. The imaged members can be cleaned between impressions, if desired, using conventional cleaning means and chemicals.

The following examples are provided to illustrate the practice of the invention but are by no means intended to limit the invention in any manner.

### EXAMPLES

The components and materials used in the examples and analytical methods were as follows. Unless otherwise indicated, the components can be obtained from various commercial sources such as Aldrich Chemical Co. (Milwaukee, Wis.).

BLO is γ-butyrolactone.

Byk® 307 is a polyethoxylated dimethylpolysiloxane copolymer that is available from Byk Chemie (Wallingford, Conn.) in a 25 wt. % xylene/-methoxypropyl acetate solution.

Copolymer A represents a copolymer having recurring units derived from N-phenylmaleimide, methacrylamide, and methacrylic acid (45:35:20 mol %) using conventional conditions and procedures.

Copolymer B is a the product obtained by stirring 20 g of Copolymer A dissolved in 100 g of methoxyethanol with 0.19 g of sodium hydroxide and 3.53 g of IR Dye A (shown below), precipitating after 4 hours in 1 liter of water, filtering, and drying the product at 40° C. for 24 hours.

DEK represents diethyl ketone.

Dowanol® PM is propylene glycol methyl ether that was obtained from Dow Chemical (Midland, Mich.). It is also known as PGME.

EP25D40G and EP25D50G are xylenol-cresol resin that was obtained from DKSH Italia (Milan, Italy).

Ethyl violet is assigned C.I. 42600 (CAS 2390-59-2, λₘₐₓ=596 nm) and has a formula of p-(CH₃CH₂)₂NC₆H₄)₃C⁺Cl⁻.

GP649D99 represents a resole resin that was obtained from Georgia-Pacific (Atlanta, Ga.).

IR Dye A (Trump) is represented by the following formula and can be obtained from Eastman Kodak Company (Rochester, N.Y.):

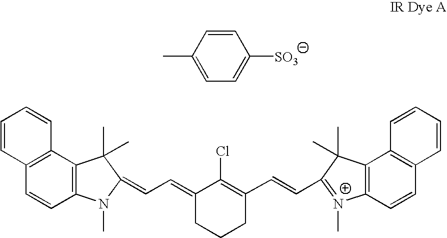

LB744 represents a cresol novolak that was obtained from Hexion Specialty Chemicals (Columbus, Ohio).

N13 represents an m-cresol novolak that was obtained from Eastman Kodak (Rochester, N.Y.).

PD494 represents an m/p cresol novolak that was obtained from Hexion Specialty Chemicals (Louisville, Ky.).

PMA represents 1-methoxy-2-propyl acetate.

RAR 62 is a polymer with the following structure and prepared using known conditions and procedures:

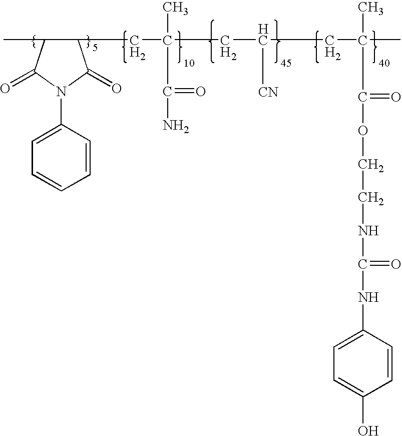

Substrate A is a 0.3 mm gauge aluminum sheet that had been electrograined, anodized, and subjected to treatment poly(vinyl phosphonic acid).

T183-5 Developer is available from Eastman Kodak Company (Norwalk, Conn.).

TN13 represents a 15 mole % tosylated form of N13 (defined above).

### Invention Examples 1-6 and Comparative Examples 1-2

Imageable elements of the present invention and Comparative elements were prepared as follows:

Inner layer formulation 1 was prepared by dissolving Copolymer A (5.80 g), RAR 62 (1.5 g), GP649D99 (4.16 g), Byk® 307 (0.05 g), and IR Dye A (1.50 g) in 130 ml of a solvent mixture comprising MEK (45 wt. %), PGME (35 wt. %), BLO (10 wt. %), and water (10 wt. %) and coating it onto Substrate A and dried at 135° C. for 45 seconds to provide a dry coating weight of 1.3 g/m².

Inner layer formulation 2 was prepared by dissolving Copolymer B in 90 ml of a solvent mixture comprising MEK (45 wt. %), PGME (35 wt. %), BLO (10 wt. %), and water (10 wt. %) and coating it onto Substrate A and dried at 135° C. for 45 seconds to provide a dry coating weight of 1.35 g/m².

Outer layer formulations were prepared by dissolving the components shown below in TABLE I in 40 g of a solvent mixture (DEK:PMA, 92:8 weight ratio), coated over the dried inner layer noted in TABLE I, and dried at 135° C. for 45 seconds to provide a dry coating weight of 0.64-68 g/m², with the exception of Invention Example 6 that had an outer layer dry coating weight of 0.40 g/m².

Samples of the resulting imageable elements were imaged at 4 W to 10 W and a drum speed of 360 rpm in steps of 1 W on a Creo® Quantum II 800 imagesetter. The imaged elements were developed with T183-5 Developer in a Mercury processor at 1000 mm/min to provide lithographic printing plates. The Clear Point of each imaged plate is noted in TABLE I. “Clear point” refers to the minimum exposure energy needed to obtain a clean background with development. All of the imaged elements had good resolution at regular exposures at 20% more energy than at the Clear Point and also at higher energies.

TABLE I

| | | | | | | | | | Clear Point |
|---|---|---|---|---|---|---|---|---|---|
| Element | Inner Layer | N13 | EP25D50G | PD494 | LB744 | EP25D40G | TN13 | BYK307 | (mJ/cm²) |
| Invention Example 1 | 1 | 2.38 | 0 | 0 | 0 | 0 | 0 | 0.030 | 53 |
| Invention Example 2 | 1 | 0 | 2.38 | 0 | 0 | 0 | 0 | 0.030 | 53 |
| Invention Example 3 | 1 | 0 | 0 | 2.38 | 0 | 0 | 0 | 0.030 | 58 |
| Invention Example 4 | 1 | 0 | 0 | 0 | 2.38 | 0 | 0 | 0.030 | 53 |
| Comparative | 1 | 0 | 0 | 0 | 0 | 0 | 2.38 | 0.030 | 93 |
| Example 1 | | | | | | | | | |
| Invention Example 5 | 2 | 0 | 0 | 2.38 | 0 | 0 | 0 | 0.030 | 64 |
| Invention Example 6 | 1 | 0 | 0 | 0 | 0 | 2.38 | 0 | 0.030 | 86 |
| Comparative | 2 | 0 | 0 | 0 | 0 | 0 | 2.38 | 0.030 | Not available |
| Example 2 | | | | | | | | | |

Plate sensitivity in a platesetter using a fiber device for imaging was evaluated by imaging several imageable elements at 1000 rpm and from 30% Energy to 100% Energy in steps of 10%. The Clear Point and the measured “Omron values” at each exposure energy are shown in TABLE II below.

The changes in the physical or morphological properties (such as surface deformities or differences in gloss) of the outer layer were measured using an Omron sensor (obtainable from Omron Electronic Components distributors) that is a commonly used electronic device in commercial platesetters. The Omron sensor detects plate “fly-off” or plate “double loading”, which are errors that can occur during imaging. In some commercial platesetters, a false signal may result from too large a surface distortion in the upper layer, and this false signal may cause imaging to be stopped in the platesetter.

To evaluate the response of the element in this invention to the Omron sensor, a setup was made to simulate the signal received during imaging. To do this, the Omron sensor was mounted over a moveable table (300×500 mm in size) that was adjusted to move at 0.3 m/sec. A sample imageable element (300×500 mm in size) was imaged using a 2-cm alternating 100% image/non-image pattern in a scanning direction. Such imaged element was placed onto the moveable table and held down using iron weight bars to avoid major signal differences due to unevenness or distortions in the outer layer surface. Before the measurements were made, the Omron sensor was tuned to a non-exposed region to read a “baseline” value for that region. The average signal difference (measured in Volts) across the exposed and non-exposed regions of the imaged element, which the sensor detects when the element moves with the moving table, provided the “Omron value”. Smaller distortions in the outer layer surface cause smaller Omron values, which are desired, as this will not then lead to a false signal that would shut down imaging in the platesetter.

TABLE II

| | Invention | Invention | Comparative |
|---|---|---|---|
| Energy in % | Example 3 | Example 2 | Example 1 |
| 40% | 0.01 | 0.01 | 0.01 |
| 50% | 0.022 | 0.065 | 0.093 |
| 60% | 0.066 | 0.069 | 0.118 |
| 70% | 0.222 | 0.224 | 0.33 |
| 80% | 0.393 | 0.419 | 0.339 |
| 90% | 0.432 | 0.458 | 0.359 |
| 100% | 0.507 | 0.54 | 0.392 |
| Clear Point Energy | 40% | 40% | 70% |
| Omron value at | 0.022 | 0.065 | 0.339 |
| regular exposure | | | |

The results obtained with the imaged elements of Invention Examples 2 and 3 and Comparative Example 1, developed in the noted “high pH developer, show that with the improved speed, a low Omron value was detected so that the “fly-off” problems were solved using the outer layer formulations according to the present invention.

The invention has been described in detail with particular reference to certain preferred embodiments thereof, but it will be understood that variations and modifications can be effected within the spirit and scope of the invention.

1. A method of making an imaged element comprising:
A) imagewise exposing an imageable element using a source of radiation to provide both exposed and non-exposed regions in said imageable element, and
B) developing said imagewise exposed imageable element with a developer having a pH greater than 11 to remove said exposed regions,
wherein said imageable element comprises a substrate having thereon, in order:
an inner layer comprising a first polymeric binder, and
an ink receptive outer layer comprising a second polymeric binder that: (1) is different than said first polymeric binder, (2) is soluble in said developer having a pH greater than 11, and (3) is a resin having phenolic hydroxy groups,
said outer layer being substantially free of dissolution suppressing components for said second polymeric binder.

2. The method of claim 1 wherein said second polymeric binder is present in said outer layer at a dry coverage of from about 30 to 100 weight % based on outer layer total dry weight.

3. The method of claim 1 wherein said second polymeric binder is a novolak resin, resole resin, or a mixture of novolak and resole resins.

4. The method of claim 1 wherein said dissolution suppressing components are present in said outer layer in an amount of less than 1 weight %.

5. The method of claim 1 wherein said imageable element further comprises an infrared radiation absorbing compound.

6. The method of claim 5 wherein said infrared radiation absorbing compound is an IR absorbing dye having a maximum absorption at from about 700 to about 1200 nm and is present only in said inner layer in an amount of at least 3 weight %.

7. The method of claim 1 wherein said first polymeric binder is a (meth)acrylic resin comprising carboxy groups, a maleated wood rosin, a styrene-maleic anhydride copolymer, a (meth)acrylamide polymer, a (meth)acrylonitrile polymer, a polymer derived from an N-substituted cyclic imide, a polymer having pendant cyclic urea groups, and polymers derived from an N-alkoxyalkyl methacrylamide.

8. The method of claim 1 wherein said inner layer has a dry coating coverage of from about 0.5 to about 2.5 g/m² and said outer layer has a dry coating coverage of from about 0.2 to about 2 g/m².

9. The method of claim 1 wherein said developer has a pH greater than 12.5.

10. The method of claim 1 wherein said developer further comprises a coating-attack suppressing agent.

11. The method of claim 10 wherein said coating-attack suppressing agent is a polyethoxylated, polypropoxylated, or polybutoxylated compound.

12. The method of claim 1 that provides a lithographic printing plate.

13. A method of making an imaged lithographic element comprising:
A) imagewise exposing an imageable lithographic printing plate precursor using a source of infrared radiation to provide both exposed and non-exposed regions in said imageable precursor, and
B) developing said imagewise exposed imageable lithographic printing plate precursor with a developer having a pH of 12 or more to remove said exposed regions,
wherein said lithographic printing plate precursor comprises an aluminum substrate having thereon, in order:
an inner layer comprising a first polymeric binder and an IR absorbing dye having a maximum absorption at from about 700 to about 1200 nm and is present only in said inner layer in an amount of at least 3 weight %, and
an ink receptive outer layer comprising a second polymeric binder that: (1) is different than said first polymeric binder, (2) is soluble in said developer having a pH of 12 or more, (3) is a novolak resin, and (4) is present in said outer layer at a dry coverage of from about 75 to 100 weight % based on outer layer total dry weight,
wherein dissolution suppressing components for said second polymeric binder are absent or present in said outer layer in an amount of less than 0.5 weight %.

14. The method of claim 13 wherein said outer layer consists essentially of one or more of said second polymeric binders.

15. The method of claim 13 wherein said first polymeric binder comprises one or more of the following resins:
1) a copolymer having pendant carboxy groups and that is derived from one or more of a (meth)-N-substituted cyclic imide, a cyclic urea monomer, (meth)acrylonitrile, 2-[3-(4-hydroxyphenyl)ureido]ethyl(meth)acrylate, and N-alkoxyalkyl (meth)acrylamide, or
2) a resole,

16. The method of claim 15 wherein said first polymeric binder comprises one or more of the following resins:
1) a copolymer comprising pendant carboxy groups and that is derived from a (meth)acrylamide and an N-substituted cyclic imide,
2) a resole, or
3) a copolymer having pendant carboxy groups and that is derived from one or more of a (meth)acrylamide, an N-substituted cyclic imide, 2-[3-(4-hydroxyphenyl)ureido]ethyl methacrylate, and acrylonitrile.
